(19) United States
(12) Patent Application Publication
(10) Pub. No.: US 2002/0009903 A1
(43) Pub. Date: Jan. 24, 2002

(54) Device for electrically powering user devices present on a part of houshold electrical appliance which is moveable relative to the main structure of this latter

(76) Inventor: Roberto Malnati, Bodio Lomnago (IT)

Correspondence Address: WHIRLPOOL PATENTS COMPANY - MD 0750, 500 RENAISSANCE DRIVE - SUITE 102, ST. JOSEPH, MI, 49085, US

(21) Appl. No.: 09/897,862

(22) Filed: Jul. 2, 2001

(30) Foreign Application Priority Data
Jul. 4, 2000 (IT) MI2000U000400

(51) Int. Cl. H01R 11/30

(52) U.S. Cl. 439/38

(57) ABSTRACT

A device for electrically powering user devices present on a part of a household electrical appliance movable relative to a fixed main structure of this latter, such as a door, for example of a refrigerator, openable away from the refrigerator cabinet, electrical conductors being present in said movable part and in said fixed structure. The device comprises a magnetic induction transformer arranged to connect said electrical conductors together, said induction transformer being positioned between said movable part and said fixed structure.

### BACKGROUND OF THE INVENTION

1. Field of the Invention

The present invention relates to a device for a refrigerator cabinet having a door housing electrical components.

2. Description of the Related Art

Movable parts of household electrical appliances (such as refrigerator or dishwasher doors movable relative to a fixed main structure) are known to often carry electrically powered user devices. For example it is known to position a drink or ice dispenser on a refrigerator door, or to position on such a door the electrical controls for these user devices (or for controlling the entire refrigerator).

On the door (or cover flaps) of a dishwasher it is known to position the controls for its operation and the members for dispensing the polishing liquid and detergent.

The electric power to these user devices or control members and their possible connection to other appliance components present in the fixed structure passes through electrical conductors associated with both the movable and fixed part of the appliance.

### SUMMARY OF THE INVENTION

An object of the present invention is to provide a device which enables said electrical conductors associated with said movable part and with the fixed structure to be easily and safely connected together.

Another object is to provide a device of the stated type which is of simple construction and low cost, so as not to negatively affect the appliance cost to a substantial extent.

A further object is to provide a device of the stated type which, in the case of a refrigerator, enables the mounting of the door on the refrigerator cabinet to be reversed.

These and further objects which will be apparent to the expert of the art are attained by a device in accordance with the accompanying claims.

### BRIEF DESCRIPTION OF THE DRAWINGS

The present invention will be more apparent from the accompanying drawing, which is provided by way of non-limiting example and in which:

FIG. 1 is an exploded view of a device of the invention;

FIG. 2 is a section through the device of FIG. 1 during its use;

FIG. 3 is a section through a different embodiment of the invention during its use; and

FIG. 4 shows a part of the device of FIG. 3.

### DESCRIPTION OF THE PREFERRED EMBODIMENT

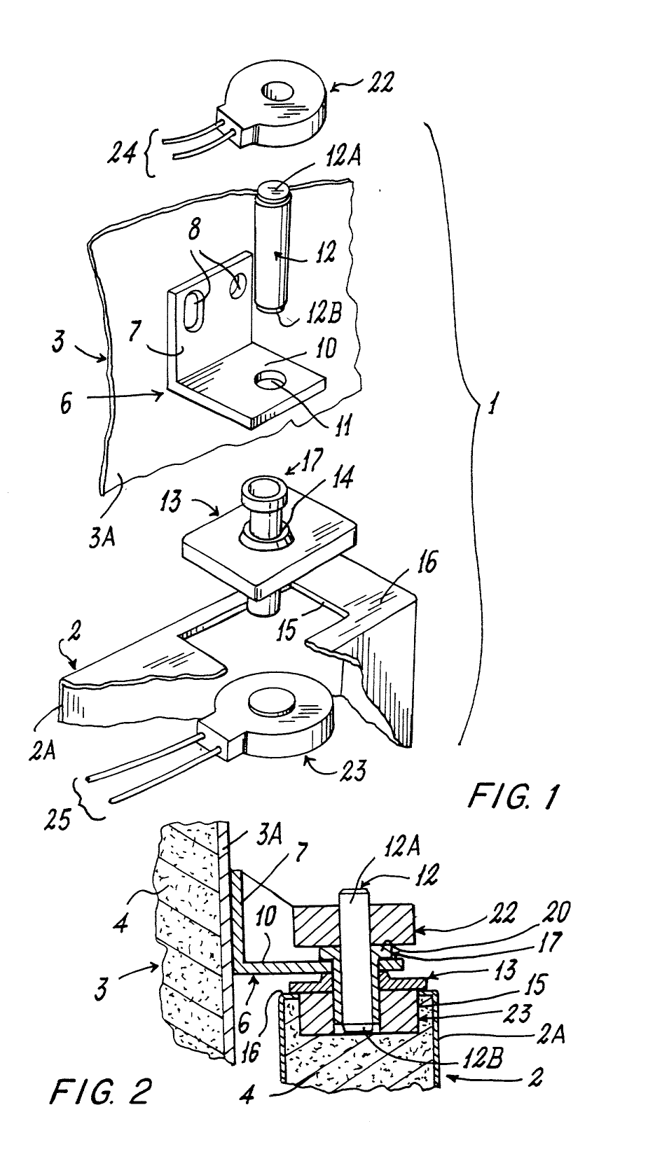

With reference to FIGS. 1 and 2, a device according to the invention is indicated overall by 1, its purpose being to act as a connection hinge between a refrigerator door 2 and the cabinet or fixed main structure 3 of this latter. Both the door 2 and the cabinet 3 comprise an outer shell 2A and 3A respectively, enclosing insulating material 4, for example expanded polyurethane.

The device 1 (which, as stated, acts as a hinge in the figures under examination), comprises a (non-metal) support element 6 of L-shape presenting, on one side 7, through holes 8 for its adjustable fixing to the structure 3. On the other side 10, the element 6 comprises a though hole 11 to receive a pin 12 acting as a metal hinge pin. The pin 12 also cooperates with a member 13 (acting as a bush), preferably of anti-friction plastic, provided with a hole 14 to receive the pin 12. This member or bush (which acts as a rotation seat for the pin 12) is inserted into a seat 15 provided on one side 16 of the door 2. Between the pin and the hole 14 there is preferably present a tube piece 17 (for protecting the pin) into which the pin 12 is inserted and which is provided with an end flange 20 resting on the side 10 of the element 6.

At the opposing ends 12A and 12B of the pin 121 there are provided two (annular) coils 22 and 23 connected to electrical conductors 24 and 25 respectively. The conductors 24 are connected in known manner to a usual alternating current mains power supply; the conductors 25 are connected to one or more electrical user devices provided on or inside the door 2. These user devices can be for example a refrigerator control panel or a drink or ice dispenser.

In this manner the combination of the coils 22 and 23 plus metal pin 12 defines a transformer in which the pin constitutes the core. Consequently, by means of the invention, electrical power can be transferred by magnetic induction from the conductors 24 to the conductors 25 via the aforesaid transformer.

The solution is simple, is of easy implementation and is of safe use (for the user) as a reduction in the voltage fed to the conductors 25 can be obtained by means of the transformer.

This reduction could also be obtained upstream of the coil 22 (which in the example is instead fed with mains voltage).

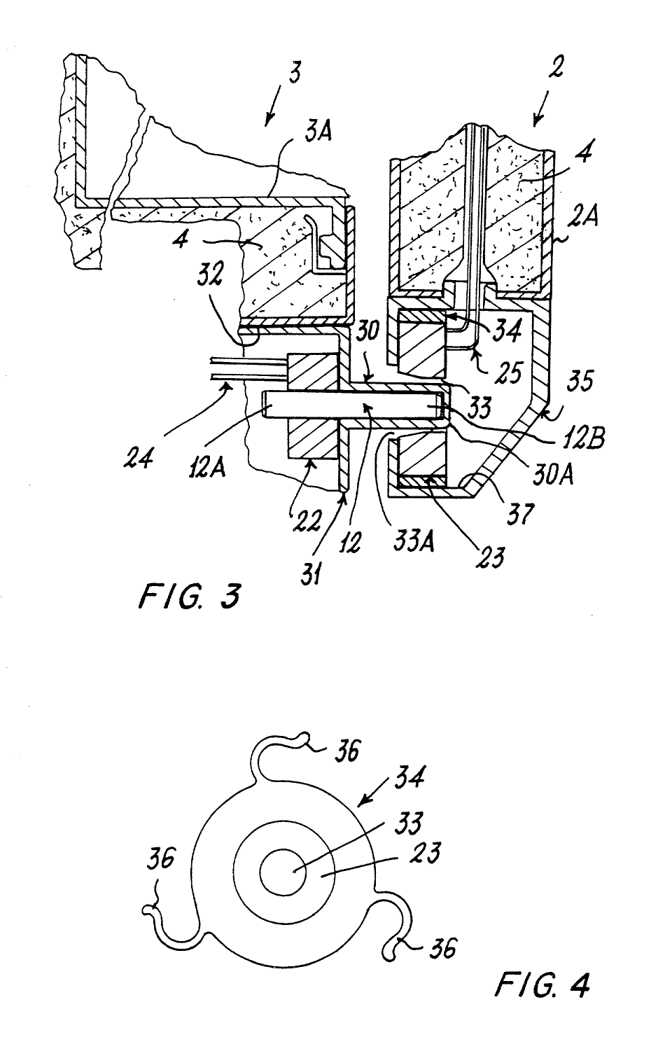

A variant of the invention is shown in FIGS. 3 and 4, in which parts corresponding to those already described are indicated by the same reference numerals. In the embodiment under examination, the pin 12 is at least partly inserted into a projecting part 30 of a member 31 (of electrically insulating diamagnetic material) associated with one side 32 of the fixed structure 3 of the refrigerator; this member can be positioned below said structure to act as a container for electrical equipment of the refrigerator. The member 31 can however also be positioned on any other side of the structure 3 against which the door 2 closes.

The projecting part 30 cooperates with a seat 33 (preferably flared at 33A), provided within a member 34 (of electrically insulating diamagnetic material) inserted into a support piece 35 associated with the door 2; the member 34 carries the coil 23 (which defines the seat 33) and presents elastic projections 36 cooperating with the walls 37 of the part 35 to enable the member 34 to undergo small movements during the insertion of the end 30A of the projecting part 30 into the seat 33 and hence receive this projecting part correctly and without jamming.

In the case under examination, the pin 12 does not act as a hinge pin, but cooperates with the coil 23 (to define, together with the coil 22 associated with the member 31, the transformer for transferring power from the conductors 24 to the conductors 25 by magnetic induction) only when the door 2 is closed against the fixed structure of the appliance. This solution is particularly suitable if the user device or devices connected to the conductors 24 or 25 are provided with their own rechargeable batteries by which these user devices operate when the door 2 is open.

A particular embodiment of the invention applied to a refrigerator has been described. The invention is however applicable to any household electrical appliance in which a part removable relative to a fixed structure supports electrically powered members, such as a dishwasher.

I claim:

1. A device for electrically powering user devices present on a part of a household electrical appliance movable relative to a fixed main structure of this latter, such as a door, for example of a refrigerator, openable away from the refrigerator cabinet, electrical conductors being present in said movable part and in said fixed structure, said device comprising magnetic induction transformer arranged to connect said electrical conductors together at least when said movable part is closed against the fixed structure.

2. A device as claimed in claim 1, wherein the magnetic induction transformer is associated with a hinge connecting the movable part to the fixed structure.

3. A device as claimed in claim 2, wherein the magnetic induction transformer comprises an elongate metal body acting as a hinge pin associated with electrical windings disposed at opposite ends of said body, the windings being connected to corresponding electrical conductors associated with the movable part or with the fixed structure.

4. A device as claimed in claim 3, wherein the metal body acting as the hinge pin is positioned through a hole in a part of a hinge support member to be secured to the fixed structure, said body cooperating with a member of electrically insulating diamagnetic material acting as a rotation seat for the hinge pin and associated with the movable part, in said movable part there being inserted a first of the two electrical windings associated with the metal body.

5. A device as claimed in claim 4, wherein the support member is of electrically insulating diamagnetic material.

6. A device as claimed in claim 5, wherein the support member and the member acting as the rotation seat for the hinge pin are of plastic material.

7. A device as claimed in claim 4, wherein the second winding is external to the fixed structure.

8. A device as claimed in claim 1, wherein the magnetic induction transformer is associated with said movable part and said fixed structure, and operates to connect said electrical conductors only when said movable part is closed against said fixed structure.

9. A device as claimed in claim 8, wherein the magnetic induction transformer comprises electrical windings, inserted one into one of said movable part and said fixed structure and the other into the other thereof, one of said windings being permanently ssociated with an elongate metal body.

10. A device as claimed in claim 9, wherein the elongate metal body is inserted into a projecting part of a member of electrically insulating diamagnetic material, said projecting part being associated with either the fixed structure or the movable part and projecting upwards between said structure and said movable part.

11. A device as claimed in claim 10, wherein the projecting part is associated with the fixed structure.

12. A device as claimed in claim 10, wherein when the movable part is closed against the fixed structure, the projecting part cooperates with a seat provided in a member elastically movable within a containing piece, to enable the projecting piece to be self-centered within said seat.

13. A device as claimed in claim 12, wherein the elastically movable member contains an electrical winding positioned about the seat for said projecting part.

14. A device as claimed in claim 12, wherein the elastically movable member is of electrically insulating diamagnetic material.

15. A device as claimed in claim 1, wherein the magnetic induction transformer is positioned on sides of the movable part and of the fixed structure which automatically face each other when said part is closed against said structure.
